(19) United States
(12) Patent Application Publication
(10) Pub. No.: US 2022/0105618 A1
(43) Pub. Date: Apr. 7, 2022

(54) Bearing Flange for a Drive System of a Hand-Held Power Tool, and Hammer Drill Having an Impact Mechanism and a Bearing Flange

(71) Applicant: Robert Bosch GmbH, Stuttgart (DE)

(72) Inventors: Fritz Schlegel, Stuttgart (DE); Holger Froehling, Stuttgart (DE)

(21) Appl. No.: 17/484,436

(22) Filed: Sep. 24, 2021

(30) Foreign Application Priority Data
Oct. 1, 2020 (DE) 10 2020 212 425.6

(51) Int. Cl. B25D 17/00; F16C 19/06; F16C 35/06; B25D 11/06

(52) U.S. Cl. CPC B25D 17/00; F16C 19/06; F16C 35/06; B25D 16/00; F16C 2352/00; B25D 2250/335; B25D 11/062

(57) ABSTRACT

A bearing flange for a drive system of a hand-held power tool includes a first bearing point for a driveshaft of a drive motor, a second bearing point for an intermediate shaft, and a third bearing point for a hammer tube. At least one bearing point includes a ball bearing, which is received in a receiving opening of the bearing flange and is axially secured therein by a snap ring.

This application claims priority under 35 U.S.C. § 119 to application no. DE 10 2020 212 425.6, filed on Oct. 1, 2020 in Germany, the disclosure of which is incorporated herein by reference in its entirety.

The disclosure relates to a bearing flange for a drive system of a hand-held power tool, and to a hammer drill having an impact mechanism and a bearing flange.

### BACKGROUND

Angular gears in electric tools, for example hammer drills, are known from the market. An intermediate shaft having a crown wheel is supported via a bearing flange which is screwed onto an intermediate flange from the rear. The bearing flange comprises an overmolded ball bearing. General disclosures in this field are U.S. Pat. No. 4,770,254 A, EP 0 771 620 A1 and US 2019/0118352 A1.

### SUMMARY

The problem addressed by the disclosure is solved by a bearing flange and a hammer drill having the features disclosed herein.

An advantage of the disclosure is that it is very easy to fix the ball bearing in the receiving opening of the bearing flange. A further advantage of the disclosure is that the bearing for the intermediate shaft and the intermediate shaft itself can be inserted into the receiving opening of the bearing flange from the same side. This, too, considerably simplifies assembly.

Specifically, this is achieved by a bearing flange for a drive system of a hand-held power tool. Said bearing flange comprises a first bearing point for a driveshaft of a drive motor, a second bearing point for an intermediate shaft, and a third bearing point for a hammer tube. By way of such a bearing flange, the entire drive system of the hand-held power tool is thus in principle supported by an integral component. At least one bearing point comprises a ball bearing, which is received in a receiving opening of the bearing flange and is axially secured therein by means of a snap ring.

Specifically, this is also achieved by a hammer drill having an impact mechanism and a bearing flange with a bearing point for receiving a bearing, which supports the end of an intermediate shaft of the impact mechanism. The bearing point has a receiving opening in which the bearing is received from one side. The intermediate shaft can be inserted into the receiving opening from the same side as the bearing.

In one development of the bearing flange, the snap ring is axially secured in the receiving opening of the bearing flange by at least one embossed or calked connection. As a result, the axial play of the snap ring and as a result also of the bearing is again considerably reduced, this being able to have an advantageous effect on the lifetime of the hand-held power tool. This is based on the fact that, in order for it to be possible to fit the snap ring in the groove, a degree of play is required. This play has a negative effect on the toothing of an angular gear, however. This is because angular gears are generally set by means of setting plates in order to reduce noise and wear. As a result of the calked connection, the play in the bearing point is reduced, and it is thus possible to dispense with setting of the angular gear.

In one development of the bearing flange, the snap ring is in the form of a tapered ring for the substantially play-free fixing, preferably axial fixing, of the ball bearing. As a result of this, too, the axial play of the snap ring and thus of the bearing is considerably reduced and the lifetime of the hand-held power tool improved.

In one development of the bearing flange, the bearing point with the snap ring is the second bearing point, that is to say the one for the intermediate shaft. Such an intermediate shaft is, as part of an impact mechanism, exposed to particularly heavy loads during operation of the hand-held power tool, and so it is particularly advantageous to reduce the axial play of the bearing there.

In one development of the hammer drill, the intermediate shaft is secured in the bearing by a securing means, wherein the securing means is able to be inserted from that side of the receiving opening that faces axially away from the intermediate shaft. As a result, assembly is considerably easier and the heavily loaded intermediate shaft is held securely in the bearing. As a result of the small opening for fitting the securing means, the entire machining of the intermediate flange can take place from two sides/directions.

In one development of the hammer drill, the securing means is a screw. This is easy to fit.

In one development of the hammer drill, the bearing comprises a ball bearing. This can withstand significant loads and is inexpensive.

In one development of the hammer drill, the bearing flange is a bearing flange. Thus, a hammer drill is created which is extremely stable, has a long lifetime, and can nevertheless be assembled easily and inexpensively.

In one development of the hammer drill, the latter comprises a pneumatic impact mechanism, in particular a wobble impact mechanism. In such an impact mechanism, the abovementioned advantages are particularly pronounced.

### BRIEF DESCRIPTION OF THE DRAWINGS

In the following text, embodiments of the disclosure are explained with reference to the drawing, in which:

FIG. 1 shows a perspective sectional illustration through a region of a hand-held power tool in the form of a hammer drill;

FIG. 2 shows a partially exploded perspective illustration of a bearing flange with three bearing points, of which one comprises a ball bearing, and with an intermediate shaft;

FIG. 3 shows a perspective sectional illustration of the bearing flange from FIG. 2, wherein the ball bearing has been inserted into the bearing flange;

FIG. 4 shows a longitudinal section through the bearing flange from FIG. 3;

FIG. 5 shows a longitudinal section through the bearing flange from FIG. 3 with an inserted and screw-connected intermediate shaft;

FIG. 6 shows a plan view of the bearing point of the bearing flange in FIGS. 1-5 with the ball bearing and a snap ring with a plurality of embossments;

FIG. 7 shows a perspective and enlarged view of one of the embossments from FIG. 6; and

FIG. 8 shows a schematic section through a region of the bearing point of the bearing flange with the ball bearing in an alternative embodiment with a tapered ring.

### DETAILED DESCRIPTION

In the following text, functionally equivalent elements and regions bear the same reference signs even in different figures and in different embodiments. Furthermore, for reasons of clarity, all the possible reference signs are not recorded in all of the figures.

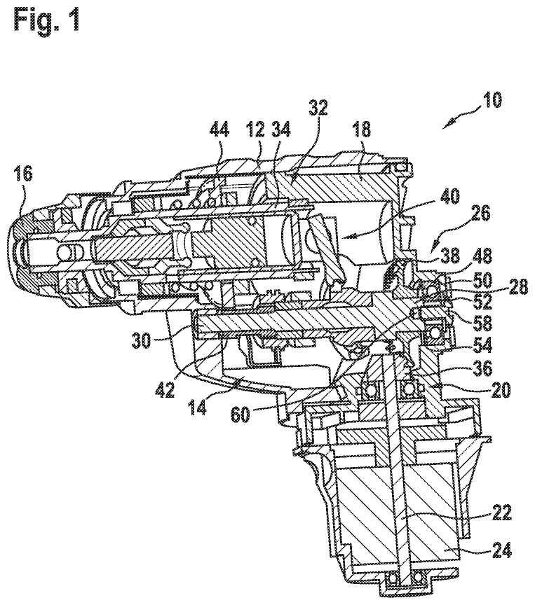

A hand-held power tool which in the present case is in the form, for example, of a hammer drill bears the reference sign 10 overall in FIG. 1. The hammer drill 10 comprises a drive-side housing 12, which is usually referred to as an impact-mechanism housing or transmission housing and in which a drive system 14 for a tool spindle 16 is accommodated. The hammer drill 10 also comprises a further housing part, which is not illustrated in the figures, however. This further housing part would comprise, inter alia, a battery pack, a handle and a release button. The housing 12 is preferably produced from a plastics material.

The drive system 14 comprises a one-piece and integral bearing flange 18. The latter is preferably made of metal and comprises a first bearing point 20 for a driveshaft 22 of an electric drive motor 24, a second bearing point 26 for a right-hand end 28, in FIG. 1, of an intermediate shaft 30, and a third bearing point 32 for a hammer tube 34. The hammer tube 34 can rotate and has axial play. In the hammer tube there is a piston (without a reference sign), which can move in translation.

Fitted on the driveshaft 22 of the electric drive motor 24 is a pinion 36, which meshes with a crown wheel 38 that is firmly connected to the intermediate shaft 30. The intermediate shaft 30 is part of a pneumatic wobble impact mechanism 40. Via a pinion 42, connected to the intermediate shaft 30, and a gearwheel 44, the tool spindle 16 is driven in rotation.

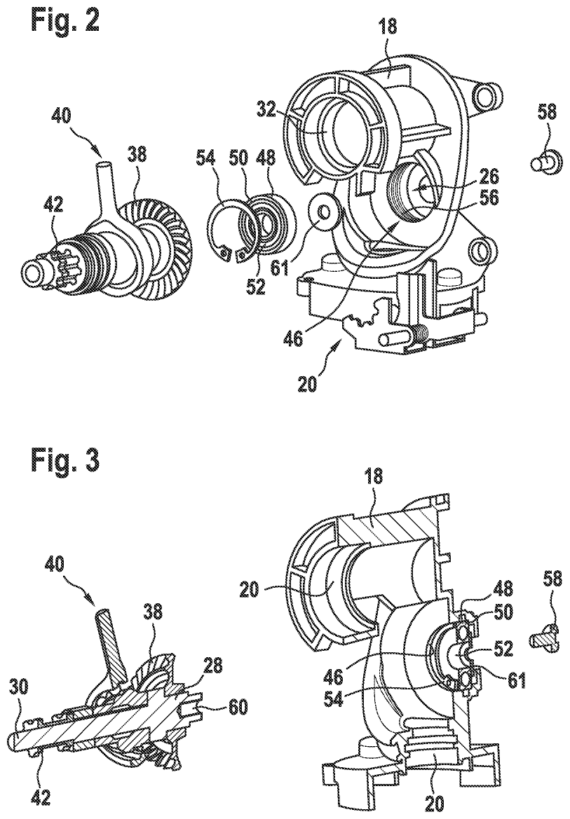

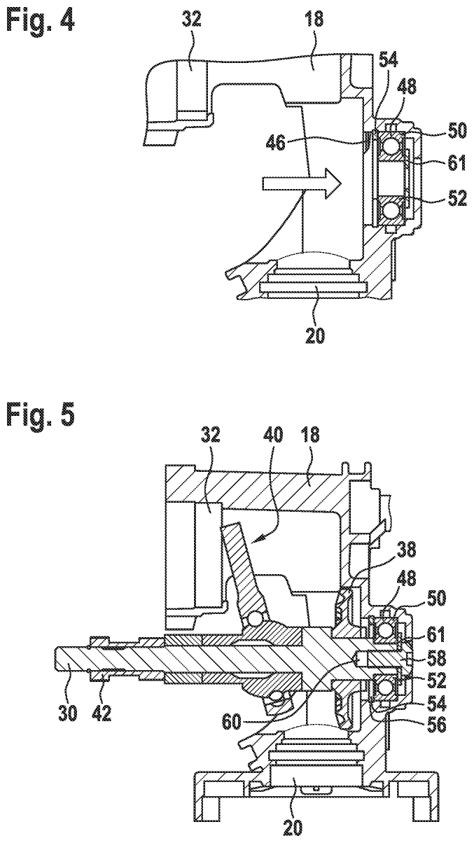

Now, with reference to FIGS. 2-5, the second bearing point 26 will be discussed in greater detail. The latter comprises a receiving opening 46 in the bearing flange 18. The receiving opening 46 is configured in the form of a pocket. A ball bearing 48 has been inserted into the receiving opening 46 from the left in the figures.

The ball bearing 48 has an outer ring 50 that is stationary with respect to the bearing flange 18, and a rotatable inner ring 52. It is axially secured by means of a snap ring 54, which is received regionally in a groove 56 in the circumferential wall of the receiving opening 46 (the snap ring 54 bears on the outer ring 50 of the ball bearing 48).

As is apparent from FIGS. 2-5, during the assembly of the drive system 14, first of all the ball bearing 48 is inserted into the receiving opening 46 and is axially secured in the receiving opening 46 by means of the snap ring 54. Then, from the same side, i.e. from the left in the figures, the intermediate shaft 30 is introduced, with the right-hand end 28 in the figures at the front, into the ball bearing 48. Both the ball bearing 48 and the intermediate shaft 30 are thus inserted from that side of the bearing point 26 that faces axially toward the intermediate shaft 30 of the impact mechanism 40.

The intermediate shaft 30 is secured to the ball bearing 48 by a securing means, which, in the present case, is, for example, a screw 58. The screw 58 is introduced from that side of the receiving opening 46 that faces axially away from the intermediate shaft 30, i.e. in the present case from the right, and is screwed into a threaded hole 60 in the end side (without a reference sign) of the intermediate shaft 30. As a result, the intermediate shaft 30 is firmly connected to the inner ring 52 of the ball bearing 48, wherein a clamp ring 61 in the form of a washer can be arranged between a head (without a reference sign) of the screw 58 and the inner ring 52 of the ball bearing 48. Said clamp ring 61 is not absolutely necessary. A screw 58 with a larger head could also easily be used.

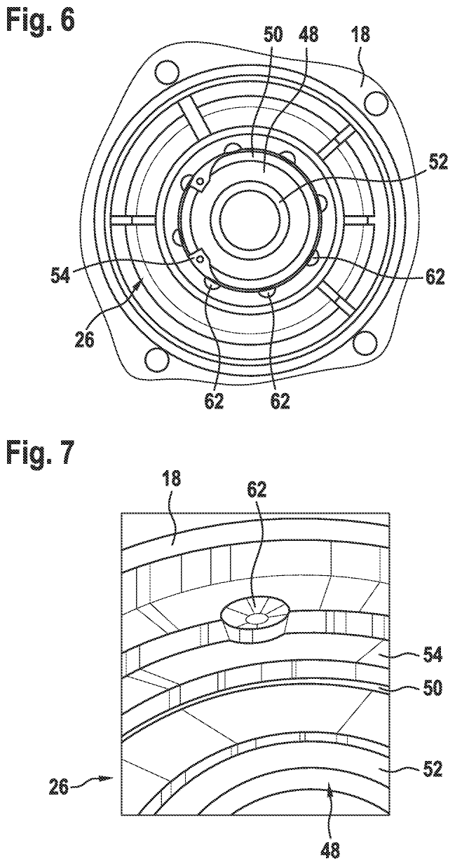

In order to minimize the axial play of the snap ring 54 and, as a result, also of the ball bearing 48, the snap ring 54 is additionally secured by a plurality of embossments or calked connections 62 arranged in a uniformly distributed manner in the circumferential direction of the receiving opening 46, as can be seen in FIGS. 6 and 7.

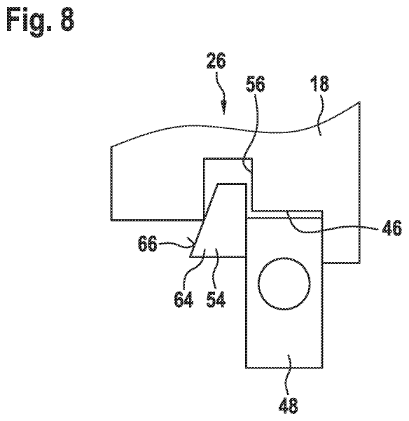

In an alternative embodiment, instead of a conventional snap ring 54 having a substantially rectangular cross section, it is also possible to use a snap ring 54 in the form of a tapered ring 64, as can be seen in FIG. 8. Such a tapered ring 64 is preloaded radially toward the outside in a similar manner to a normal snap ring 54, and has an oblique end face 66 that faces away from the ball bearing 48 in the present case. As a result of being preloaded radially toward the outside, the oblique end face 66 cooperates with a radially inner edge of the groove 56 such that the tapered ring 64 is urged in the axial direction toward the ball bearing 48. In this way, the latter is likewise held axially in the receiving opening 46 reliably and in a virtually play-free manner.

1. A bearing flange for a drive system of a hand-held power tool, comprising:
a first bearing point for a driveshaft of a drive motor;
a second bearing point for an intermediate shaft; and
a third bearing point for a hammer tube,
wherein at least one of the first, second, and third bearing points comprises:
a ball bearing received in a receiving opening of the bearing flange; and
a snap ring axially securing the ball bearing in the bearing flange.

2. The bearing flange according to claim 1, wherein the snap ring is axially secured in the receiving opening of the bearing flange by at least one embossment or calked connection.

3. The bearing flange according to claim 1, wherein the snap ring is in the form of a tapered ring for the substantially play-free fixing of the ball bearing.

4. The bearing flange according to claim 3, wherein the tapered ring axially fixes the ball bearing

5. The bearing flange according to claim 1, wherein the at least one of the first, second, and third bearing points is the second bearing point.

6. A hammer drill comprising:
an impact mechanism having an intermediate shaft; and
a bearing flange comprising a first bearing point, which receives a bearing that supports an end of the intermediate shaft, the first bearing point having a receiving opening in which the bearing is received from a first side and into which the intermediate shaft insertable from the first side.

7. The hammer drill according to claim 6, wherein the intermediate shaft is secured in the bearing by a securing device, which is insertable into a second side of the receiving opening that faces axially away from the intermediate shaft.

8. The hammer drill according to claim 7, wherein the securing device is a screw.

9. The hammer drill according to claim 6, wherein the bearing comprises a ball bearing.

10. The hammer drill according to claim 9, wherein the bearing flange further comprises:
a second bearing point for a driveshaft of a drive motor; and
a third bearing point for a hammer tube, wherein the first bearing point further comprises a snap ring axially securing the ball bearing in the bearing flange.

11. The hammer drill according to claim 6, wherein the impact mechanism is a pneumatic impact mechanism.

12. The hammer drill according to claim 11, wherein the pneumatic impact mechanism is a wobble impact mechanism.
